(19) United States
(12) Patent Application Publication
(10) Pub. No.: US 2025/0372769 A1
(43) Pub. Date: Dec. 4, 2025

(54) HEAT INSULATING SHEET FOR RECHARGEABLE LITHIUM BATTERY AND RECHARGEABLE LITHIUM BATTERY MODULE INCLUDING THE SAME

(71) Applicants: SAMSUNG SDI CO., LTD., Yongin-si (KR); DAEHYUP TECH CO., LTD., Ulju-gun, Ulsan (KR)

(72) Inventors: Seung Yong YANG, Suwon-si (KR); Myung Heui WOO, Suwon-si (KR); Jung Hyo LEE, Suwon-si (KR); Hye Jin PARK, Suwon-si (KR); Jae Hyun LEE, Suwon-si (KR); Ha Na RA, Suwon-si (KR); Yun Sung YANG, Suwon-si (KR)

(73) Assignees: SAMSUNG SDI CO., LTD., Yongin-si (KR); DAEHYUP TECH CO., LTD., Ulju-gun (KR)

(21) Appl. No.: 19/221,972

(22) Filed: May 29, 2025

(30) Foreign Application Priority Data
May 31, 2024 (KR) 10-2024-0071262

(51) Int. Cl. H01M 10/658; B32B 5/02; B32B 27/12; F16L 59/02

(52) U.S. Cl. CPC H01M 10/658; B32B 5/022; B32B 27/12; F16L 59/029; B32B 2262/101; B32B 2307/304; B32B 2457/10; H01M 2220/20

(57) ABSTRACT

The present disclosure relates to a heat insulating sheet for a rechargeable lithium battery and a rechargeable lithium battery module including the heat insulating sheet. The heat insulating sheet includes a first base layer, an aerogel-containing layer, and a second base layer that are laminated. The aerogel-containing layer includes a fibrous support, an aerogel, one or more of a phosphorus-based compound and a phosphorus-based ammonium compound, and a crosslinked product of a binder and a crosslinking agent. The binder includes an alcohol-based binder, and the crosslinking agent includes a polycarboxylic acid containing a sulfonic acid group (SO₃H) or a salt thereof.

### CROSS-REFERENCE TO RELATED APPLICATION

The present application claims priority to Korean Patent Application No. 10-2024-0071262, filed on May 31, 2024 in the Korean Intellectual Property Office, the entire disclosure of which is incorporated herein by reference.

### BACKGROUND

### 1. Field of the Disclosure

The present disclosure relates to a heat insulating sheet for a rechargeable lithium battery, and to a rechargeable lithium battery module including the heat insulating sheet.

### 2. Discussion of Related Art

With increasing use of electronic devices that use batteries, such as, e.g., mobile phones, notebook computers, electric vehicles, and the like, the demand for high energy density and high capacity rechargeable batteries is increasing. Accordingly, improving the performance of rechargeable lithium batteries may be advantageous.

A rechargeable lithium battery typically includes positive and negative electrodes that include active materials capable of intercalating and deintercalating lithium ions, and an electrolyte, and produces electrical energy through oxidation and reduction reactions when lithium ions are intercalated and deintercalated into/from the positive and negative electrodes.

A plurality of rechargeable lithium batteries may be included to form a rechargeable lithium battery module. In rechargeable lithium battery modules, it may be desirable to hinder or block heat propagation and/or heat transfer between adjacent cells.

### SUMMARY OF THE DISCLOSURE

One example embodiment includes a heat insulating sheet for a rechargeable lithium battery having desired or improved heat insulation, durability, fire resistance, and moisture resistance.

Another example embodiment includes a rechargeable lithium battery module including the heat insulating sheet for a rechargeable lithium battery.

According to one example embodiment, a heat insulating sheet for a rechargeable lithium battery includes a first base layer, an aerogel-containing layer, and a second base layer that are laminated, e.g., sequentially laminated. The aerogel-containing layer includes a fibrous support, an aerogel, one or more of a phosphorus-based compound and a phosphorus-based ammonium compound, and a crosslinked product of a binder and a crosslinking agent. The binder includes an alcohol-based binder, and the crosslinking agent includes a polycarboxylic acid containing a sulfonic acid group (SO₃H) or a salt thereof.

Another example embodiment includes a rechargeable lithium battery module including a plurality of battery cells arranged to face each other, and the heat insulating sheet for a rechargeable lithium battery arranged between the plurality of battery cells.

### BRIEF DESCRIPTION OF THE DRAWINGS

The above and other objects, features and advantages of the present disclosure are more apparent to those of ordinary skill in the art by describing example embodiments thereof in detail with reference to the accompanying drawings, in which:

FIG. 1 shows a cross-sectional view of a heat insulating sheet for a rechargeable lithium battery according to one example embodiment;

FIG. 2 is a perspective view of a rechargeable lithium battery module according to one example embodiment;

FIG. 3 is an exploded perspective view of a rechargeable lithium battery module according to one example embodiment;

FIG. 4 is a cross-sectional view schematically illustrating a battery cell according to one example embodiment;

FIG. 5 is a cross-sectional view schematically illustrating a battery pack according to one example embodiment;

FIG. 6 is a cross-sectional view schematically illustrating a battery pack according to one example embodiment;

FIG. 7 shows a drawing illustrating a vehicle body and vehicle body parts according to one example embodiment;

FIG. 8 shows a drawing illustrating a vehicle body and vehicle body parts according to one example embodiment; and

FIG. 9 shows a schematic diagram for evaluating heat insulation.

### DETAILED DESCRIPTION

Hereinafter, example embodiments of the present disclosure are described in detail. However, these embodiments are provided as an example, the present disclosure is not limited thereto, and the present disclosure is only defined by the scope of the claims to be described below.

Unless otherwise specified herein, when a part such as a layer, film, region, plate, and the like, is described as being “on” another part, the part includes not only the case where the part is “directly on” the other part, but also the case where there is still another part therebetween.

Unless otherwise specified in this specification, anything indicated in the singular may also include the plural. Further, unless otherwise stated, “A or B” may mean “including A, including B, or including A and B.”

As used herein, the term “combination thereof” may mean mixtures, laminates, composites, copolymers, alloys, blends, reaction products, and the like of the components.

As used herein, “substituted” in “substituted or unsubstituted” means that one or more hydrogen atoms in the functional group are substituted with an alkyl group having 1 to 30 carbon atoms, an alkenyl group having 2 to 30 carbon atoms, an alkynyl group having 2 to 30 carbon atoms, an aryl group having 6 to 30 carbon atoms, an alkylaryl group having 7 to 30 carbon atoms, an alkoxy group having 1 to 30 carbon atoms, a heteroalkyl group having 1 to 30 carbon atoms, a heteroalkylaryl group having 3 to 30 carbon atoms, a cycloalkyl group having 3 to 30 carbon atoms, a cycloalkenyl group having 3 to 15 carbon atoms, a cycloalkynyl group having 6 to 30 carbon atoms, a heterocycloalkyl group having 2 to 30 carbon atoms, a halogen (F, Cl, Br, or I), a hydroxy group (—OH), a nitro group (—NO₂), or a cyano group (—CN).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Heat Insulating Sheet for Rechargeable Lithium Battery

According to one example embodiment, a heat insulating sheet for a rechargeable lithium battery includes a first base layer, an aerogel-containing layer, and a second base layer that are laminated, e.g., sequentially laminated. The aerogel-containing layer includes a fibrous support, an aerogel, one or more of a phosphorus-based compound and a phosphorus-based ammonium compound, and a crosslinked product of a binder and a crosslinking agent. The binder includes an alcohol-based binder, and the crosslinking agent includes a polycarboxylic acid containing a sulfonic acid group or a salt thereof.

In one example embodiment, the crosslinked product may be or include a thermal crosslinked product.

Hereinafter, a heat insulating sheet according to one example embodiment is described in detail.

### First Base Layer

The first base layer may support the aerogel-containing layer and the second base layer in the heat insulating sheet.

The first base layer may be included as one or more layers, e.g., one layer or two or more layers, in the heat insulating sheet.

The first base layer may be or include a film, thin film, or a sheet formed of or including at least one of a resin, a metal-based inorganic material, a non-metal-based inorganic material, or a composite thereof.

The resin may include, for example, one or more of polyolefins such as at least one of polyethylene and polypropylene; polystyrenes; polyesters such as polyethylene terephthalate and polybutylene terephthalate; polyamides; and polyimides.

The metal-based inorganic material may include, for example, one or more of copper, nickel, cobalt, iron, chromium, vanadium, palladium, ruthenium, rhodium, molybdenum, tungsten, iridium, silver, gold, and platinum. The metal-based inorganic material may undergo corrosion prevention treatment or insulation treatment, as needed.

The non-metal-based inorganic material may include one or more of calcium carbonate, talc, and mica.

According to one example embodiment, the heat insulating sheet may include a non-metal-based inorganic material as the first base layer, and for example may include a mica sheet. Mica can improve the compressibility, heat insulation, and durability of the heat insulating sheet.

The first base layer may have a thickness in a range of about 10 μm to about 5000 μm, for example, 50 μm to 3000 μm, or 100 μm to 1000 μm. Within the above range, the first base layer can be used in heat insulating sheets.

### Second Base Layer

The second base layer can support the first base layer and the aerogel-containing layer in the heat insulating sheet.

The second base layer may be included as one or more layers, e.g., one layer or two or more layers, in the heat insulating sheet.

The second base layer may be laminated on the aerogel-containing layer. The aerogel-containing layer may be or include a separate layer that is independent of the second base layer. Herein, the term “independent separate layer” indicates that the aerogel-containing layer is not formed by impregnation, or the like, within the second base layer, but rather that the second base layer and the aerogel-containing layer are separated, e.g., completely separated, and formed as non-continuous layers.

The second base layer may be or include a film, thin film, or sheet formed of or including at least one of a resin, a metal-based inorganic material, a non-metal-based inorganic material, or a composite thereof. The resin, metal-based inorganic material, and non-metal-based inorganic material are substantially the same as those described in the first base layer.

According to one example embodiment, the heat insulating sheet may include a non-metal-based inorganic material as the second base layer, and for example may include a mica sheet. Mica can improve the heat insulation and durability of the heat insulating sheet.

The second base layer may have a thickness in a range of about 10 μm to about 5000 μm, for example, 50 μm to 3000 μm, or 100 μm to 1000 μm. Within the above range, the second base layer can be used in heat insulating sheets.

### Aerogel-Containing Layer

The aerogel-containing layer may be or include a separate layer that is independent of the first base layer and the second base layer. Herein, the term “independent separate layer” indicates that the aerogel-containing layer is not formed by impregnation, or the like, within the base layer, but rather that the first base layer and the aerogel-containing layer are separated, e.g., completely separated, and formed as non-continuous layers.

The aerogel-containing layer may be included as one or more layers, e.g., one layer or two or more layers, in the heat insulating sheet.

The fibrous support can help support the aerogel-containing layer and improve the compressibility of the heat insulating sheet. When the heat insulating sheet is positioned between the batteries in the module, the compressibility can relieve the stress applied to the heat insulating sheet during volume expansion during charging and discharging of the battery, and can reduce the influence of the battery when a fire occurs.

The fibrous support may be or include, for example, a wool mat or a chopped strand mat.

The fibers forming the fibrous support may include one or more of natural fibers, glass fibers, carbon fibers, graphite fibers, mineral fibers, and polymer fibers. For example, the fibrous support can have further improved compression properties by using glass fibers.

The natural fiber may be or include a fiber made of one or more of hemp, jute, flax, coir, kenaf, and cellulose. The mineral fiber may be or include a fiber made of one or more of basalt, wollastonite, alumina, silica, slag, and rock. The polymer fiber may be a fiber made of or including one or more of nylons, polyimides, polyamides, polybenzimidazoles, polybenzoxazoles, polyamideimides, polyesters such as polyethylene terephthalate or polybutylene terephthalate, and polyolefins such as polyethylene or polypropylene.

For example, the fibrous support may be or include glass wool.

The fibers in the fibrous support may have an aspect ratio in a range of about 1 or more, for example, 1 to 5,000. Within the above range, the aerogel-containing layer can be firmly formed, and the durability of the heat insulating sheet can be improved. Herein, the term “aspect ratio” refers to the ratio of the length of the fiber to the diameter of the fiber in the fibrous support.

The fibers in the fibrous support may have a length in a range of about 50 μm to about 1000 μm, for example, 70 μm to 800 μm, or 100 μm to 600 μm. Within the above range, the aerogel-containing layer can be firmly formed, and the durability of the heat insulating sheet can be improved.

The fibers in the fibrous support may have a diameter in a range of about 0.1 μm to about 20 μm, for example, 0.1 μm to 15 μm, 0.1 μm to 5 μm, 1 μm to 15 μm, or 3 μm to 10 μm. Within the above range, the aerogel-containing layer can be firmly formed, and the durability of the heat insulating sheet can be improved. Herein, the term “diameter” may refer to the diameter when the cross-section of the fiber is circular, or the longest diameter when the cross-section is not circular.

The fibrous support may be included in the aerogel-containing layer in an amount of 10 to 70 wt %. For example, the fibrous support may be included in the aerogel-containing layer in an amount of 10 to 60 wt %, 10 to 50 wt %, or 20 to 50 wt %. Within the above range, the support can readily improve the flexibility and durability of the heat insulating sheet.

The aerogel can provide a heat insulating effect to the aerogel-containing layer.

In one example embodiment, the aerogel may have a specific surface area in a range of about 500 m²/g to in a range of about 1000 m²/g. For example, the specific surface area may be in a range of 500 m²/g to 1000 m²/g, 550 m²/g to 950 m²/g, or 600 m²/g to 900 m²/g. Within the above range, it can be possible to reduce or prevent heat transfer and heat propagation between a plurality of battery cells. Herein, the “specific surface area” may be a specific surface area based on Brunauer Emmett Teller (BET) specific surface area analysis.

According to one example embodiment, the aerogel may have an average particle diameter in a range of about 5 μm to about 200 μm. For example, the aerogel may have an average particle diameter of 10 μm to 100 μm or 20 μm to 50 μm. Within the above range, it can be possible to delay heat transfer between a plurality of battery cells by improving the insulation properties of the heat insulating sheet. Herein, the term “average particle diameter” refers to the average particle diameter (D50), which indicates the diameter of particles with a cumulative volume of 50% by volume in the particle size distribution. The average particle diameter (D50) may be measured by methods well known to those skilled in the art, for example, by a particle size analyzer, transmission electron microscope (TEM) images, or scanning electron microscope (SEM) images. As another method, the particle size distribution may be measured using a measurement device using dynamic light scattering, and an average particle diameter (D50) value may be obtained by performing data analysis, counting the number of particles in each particle size range, and then calculating the average particle diameter (D50) therefrom. Alternatively, the average particle diameter may be measured using a laser diffraction method. When measuring by laser diffraction, for example, after the particles to be measured are dispersed in a dispersion medium, the particles may be introduced into a commercially available laser diffraction particle size measuring device (e.g., Microtrac MT 3000) and irradiated with ultrasonic waves of approximately 28 kHz at an output of 60 W, and the average particle size (D50) based on 50% of the particle size distribution in the measurement device may be calculated.

According to one example embodiment, the aerogel may be hydrophobically treated. Herein, the hydrophobically treated aerogel can provide a moisture-resistant effect. The hydrophobic treatment may be performed on non-surface-treated aerogels as hydrophobic surface treatment and a hydrophobic substitution operation.

The aerogel may be included in the aerogel-containing layer in an amount in a range of about 10 wt % to about 90 wt %. For example, the aerogel may be included in the aerogel-containing layer in an amount of 10 wt % to 70 wt %, 30 wt % to 70 wt %, 40 wt % to 70 wt %, or 40 wt % to 60 wt %. In the above range, the heat insulation of the heat insulating sheet can be improved.

The aerogel-containing layer includes a crosslinked product of a binder and a crosslinking agent, the binder includes an alcohol-based binder, and the crosslinking agent includes a polycarboxylic acid containing a sulfonic acid group (SO₃H) or a salt thereof.

According to one example embodiment, the aerogel-containing layer may include at least one of the alcohol-based binder, the polycarboxylic acid containing a sulfonic acid group (SO₃H), or a salt thereof. These may be derived from the composition for an aerogel-containing layer described below.

The alcohol-based binder may have a hydroxyl group connected to the main chain. The hydroxyl group may reduce the moisture resistance of the heat insulating sheet due to the affinity of the hydroxyl group for water, when remaining in the aerogel-containing layer. The aerogel-containing layer can reduce or prevent a decrease in moisture resistance due to the hydroxyl group by including a crosslinked product of the alcohol-based binder and the crosslinking agent. In addition, the aerogel-containing layer can improve the mechanical strength of the aerogel-containing layer by including a crosslinked product of the binder compared to the alcohol-based binder alone, thereby enhancing fire resistance. In addition, the alcohol-based binder can improve the dispersibility of the composition for an aerogel-containing layer including the crosslinking agent described below, thereby improving the manufacturing processibility of a heat insulating sheet.

The alcohol-based binder may have a hydroxyl group connected to the main chain. In this regard, the alcohol-based binder may include a repeating unit of the following Chemical Formula 1:

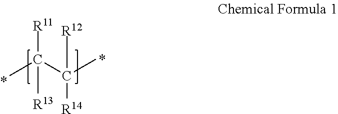

in Chemical Formula 1,
* is a connecting site of an element,
R¹¹ to R¹⁴ are each independently hydrogen, deuterium, a hydroxyl group, an unsubstituted straight or branched C1 to C5 alkyl group, or a straight or branched C1 to C5 alkyl group substituted with a hydroxyl group, and
at least one of R¹¹ to R¹⁴ is a hydroxyl group, or a straight or branched C1 to C5 alkyl group substituted with a hydroxyl group.

For example, in Chemical Formula 1, any one of R¹¹ to R¹⁴ may be a hydroxyl group or a straight or branched C1 to C5 alkyl group substituted with a hydroxyl group, and the rest may all be hydrogen or deuterium. For example, the alcohol-based binder may be or include polyvinyl alcohol.

In one example embodiment, the alcohol-based binder may be or include an aqueous binder. The aqueous binder has high solubility in water among the solvents described below, and thus may be advantageous in forming an aerogel-containing layer.

According to one example embodiment, the aerogel-containing layer may further include, in addition to the alcohol-based binder, one or more of a cationic water-soluble polymer, an anionic water-soluble polymer, and a nonionic water-soluble polymer as the binder.

The cationic water-soluble polymer is a polymer having a functional group such as or including at least one of an amine group, an ammonium group, a phosphonium group, a sulfonium group, or a salt thereof, and may be, for example, a polymer having an amine group. For example, the cationic water-soluble polymer may include one or more of polyethyleneamine and polyamine.

The anionic water-soluble polymer is or includes a polymer having a functional group such as at least one of a carboxylic acid group, a sulfonic acid group, an ester group, a phosphoric acid ester group or a salt thereof, and may be or include, for example, a polymer having a carboxylic acid group. For example, the anionic water-soluble polymer may be polymaleic acid.

The nonionic water-soluble polymer may include one or more of polyethylene glycol, polyacrylamide, polyvinylpyrrolidone, polyurethane, and polyester. The nonionic water-soluble polymer may be or include a water-dispersible or water-soluble polymer.

According to one example embodiment, the binder may include a mixture of one or more of the alcohol-based binder, polyethylene glycol, polyacrylamide, and polyvinylpyrrolidone; and one or more of polyurethane and polyester. In this case, it can be possible to provide dispersibility resulting from one or more of the alcohol-based binder, polyethylene glycol, polyacrylamide, and polyvinylpyrrolidone, and fire resistance resulting from one or more of polyurethane and polyester. For example, a mixture of the alcohol-based binder and polyurethane may be used.

According to one example embodiment, the weight ratio of one or more of the alcohol-based binder, polyethylene glycol, polyacrylamide, and polyvinyl pyrrolidone:one or more of polyurethane and polyester may be in a range of 1:1 to 1:5, for example, 1:1 to 1:4 or 1:2 to 1:3. Within the above range, the heat insulation, dust resistance, fire resistance, and mechanical properties of the heat insulating sheet can be improved.

According to one example embodiment, the alcohol-based binder in the binder may be included in an amount in a range of about 95 wt % or more, for example, 95 wt % to 100 wt %, or 100 wt %.

The binder in the composition for an aerogel-containing layer, for example, an alcohol-based binder, may be included in an amount in a range of about 0.5 wt % to about 20 wt %, for example, 2 wt % to 20 wt %, 2 wt % to 15 wt %, or 5 wt % to 15 wt %. Within the above range, the moisture resistance and fire resistance of the heat insulating sheet can be improved without affecting the heat insulation by the aerogel.

The crosslinking agent includes a polycarboxylic acid containing a sulfonic acid group or a salt thereof.

The polycarboxylic acid containing a sulfonic acid group or a salt thereof can improve the fire resistance and moisture resistance of the heat insulating sheet by crosslinking the above-described alcohol-based binder. According to one example embodiment, the crosslinking agent may be a compound having two or more, for example, two to four carboxylic acid groups.

According to one implementation example, the diagram below is a schematic diagram showing the cross-linking reaction between polyvinyl alcohol and sulfosuccinic acid.

### Schematic Diagram:

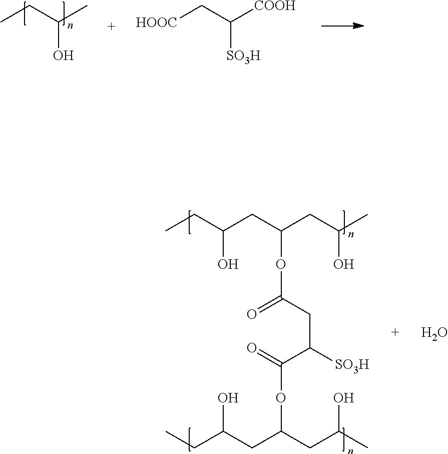

Referring to the above schematic diagram, it can be confirmed that the hydroxyl group of polyvinyl alcohol reacts with the carboxylic acid group of sulfosuccinic acid, thereby crosslinking the polyvinyl alcohol. Accordingly, moisture resistance can be improved because the hydroxyl group of polyvinyl alcohol does not remain.

Since the polycarboxylic acid containing a sulfonic acid group or a salt thereof does not undergo any crosslinking reaction at room temperature when mixed with the alcohol-based binder in the composition for an aerogel-containing layer, the polycarboxylic acid does not cause changes in viscosity of the composition for an aerogel-containing layer over time, thereby improving the storage properties of the composition for an aerogel-containing layer to improve the manufacturing processibility of the heat insulating sheet. In addition, the polycarboxylic acid containing a sulfonic acid group or a salt thereof can improve the manufacturing processibility of the heat insulating sheet by curing during the manufacturing process of the aerogel-containing layer described below without the addition of a separate catalyst or a curing process such as high-temperature treatment.

According to one example embodiment, the polycarboxylic acid containing a sulfonic acid group or a salt thereof may be or include a dicarboxylic acid and may be represented by the following Chemical Formula 2:

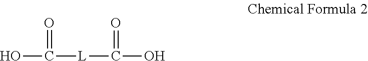

in Chemical Formula 2,
L is a straight or branched C1 to C10 alkylene group substituted with a sulfonic acid group or a salt thereof.

For example, in Chemical Formula 2, L may be a straight-chain C2 to C5 alkylene group substituted with a sulfonic acid group or a salt thereof.

In one example, the polycarboxylic acid containing a sulfonic acid group or a salt thereof may be represented by the following Chemical Formula 3:

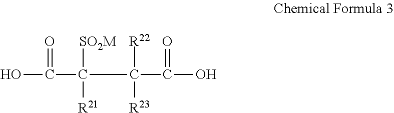

in Chemical Formula 3,
R²¹ to R²³ are each independently hydrogen, deuterium, or a substituted or unsubstituted C1 to C5 alkyl group, and
M is OH or O⁻N⁺ (where N⁺ is a monovalent metal cation).

For example, the polycarboxylic acid containing a sulfonic acid group or a salt thereof may be or include sulfosuccinic acid or a salt thereof.

According to one example embodiment, the polycarboxylic acid containing a sulfonic acid group or a salt thereof may be included in the crosslinking agent in an amount in a range of about 95 wt % or more, for example, 95 wt % to 100 wt %, or 100 wt %.

The crosslinking agent may be included in the composition for an aerogel-containing layer in an amount in a range of 0.1 wt % to about 10 wt %, for example, 0.5 wt % to 5 wt %. Within the above range, the moisture resistance and fire resistance of the heat insulating sheet can be improved without affecting the heat insulation by the aerogel.

The aerogel-containing layer includes one or more of a phosphorus-based compound and a phosphorus-based ammonium compound. One or more of the phosphorus-based compound and the phosphorus-based ammonium compound can provide a flame retardant effect.

The phosphorus-based compound may include triphenyl phosphate and the like.

The phosphorus-based ammonium compound may be or include a compound having an ammonium cation (NH₄⁺) and a phosphorus-based anion. Herein, the phosphorus-based anion may be or include a monovalent or polyvalent anion derived from phosphoric acid (H₃PO₄) or phosphorous acid (H₃PO₃). For example, the phosphorus-based ammonium compound may be or include ammonium dihydrogen phosphate, ammonium polyphosphate, and the like, and one or more of the phosphorus-based compound and the phosphorus-based ammonium compound may be included in the aerogel-containing layer in an amount in a range of about 1 wt % to about 10 wt %, for example, 2 wt % to 7 wt % or 2 wt % to 5 wt %. Within the above range, the effect of the aerogel-containing layer described above can be readily implemented.

The aerogel-containing layer may further include one or more of a dispersant and a silane-based compound.

The dispersant can improve the dispersion of the aerogel in the composition for an aerogel-containing layer, thereby enabling the manufacture of an aerogel-containing layer in which the fibrous support and the aerogel are uniformly dispersed.

The dispersant may include one or more of a surfactant and a phosphorus salt. The surfactant may include one or more of a nonionic surfactant, an anionic surfactant, and a zwitterionic surfactant. The surfactant may include one or more of natural surfactants such as lecithin and non-natural surfactants such as chemicals. The phosphorus salt may be or include a phosphate salt.

The dispersant may be included in the aerogel-containing layer in an amount in a range of about 0.1 wt % to about 6 wt %. For example, the dispersant may be included in an amount in a range of about 0.1 wt % to about 5 wt % or 0.1 wt % to 3 wt %. Within the above range, it is possible to manufacture the composition for an aerogel-containing layer at low cost and provide a heat insulating sheet with improved heat insulation, durability, and dust resistance.

According to one example embodiment, a weight ratio of the binder and the dispersant may range from about 1:0.001 to about 1:0.7, for example, from 1:0.001 to 1:0.67, from 1:0.001 to 1:0.5, or from 1:0.001 to 1:0.3. Within the above range, when the binder and dispersant are mixed, it is possible to manufacture an aerogel-containing layer in which the aerogel is more uniformly dispersed.

The silane-based compound can improve the dispersibility of the aerogel in the aerogel-containing layer.

According to one example embodiment, the silane-based compound may include one or more of alkyl group-containing trialkoxysilanes such as methyltrimethoxysilane, methyltriethoxysilane, ethyltrimethoxysilane, ethyltriethoxysilane, and octadecyltrimethoxysilane, epoxy group-containing trialkoxysilanes such as glycidoxypropyltrimethoxysilane, and unsaturated group-containing trialkoxysilanes such as 3-(trimethoxysilyl) propylmethacrylate.

The aerogel-containing layer may further include conventional additives known to those skilled in the art. The additives may include one or more of wetting agents, emulsifiers, compatibilizers, viscosity modifiers, pH-adjusting agents, stabilizers, antioxidants, acid or base scavengers, metal deactivators, defoamers, antistatic agents, thickeners, adhesion improvers, binders, flame retardants, impact modifiers, pigments, dyes, colorants, and deodorizing agents.

According to one example embodiment, the aerogel-containing layer may have a thickness in a range of about 100 μm to about 10,000 μm, for example, 500 μm to 5,000 μm, or 1,000 μm to 3,000 μm. Within the above range, the aerogel-containing layer can be used in heat insulating sheets.

The aerogel-containing layer may be formed using a composition for an aerogel-containing layer including the fibrous support, the aerogel, the alcohol-based binder, and the crosslinking agent. The composition for an aerogel-containing layer may further include one or more of the dispersant, the silane-based compound, and the additive.

In one example embodiment, the composition for an aerogel-containing layer may include, based on solid content, a range of about 10 wt % to about 70 wt %, for example 10 wt % to 60 wt %, 10 wt % to 50 wt %, or 20 wt % to 50 wt % of the fibrous support; a range of about 10 wt % to 90 wt %, for example 30 wt % to 70 wt %, 40 wt % to 70 wt %, or 40 wt % to 60 wt % of the aerogel; a range of about 0.5 wt % to 20 wt %, for example 2 wt % to 15 wt % or 6 wt % to 15 wt % of the binder; a range of about 0.1 wt % to 10 wt %, for example 0.5 wt % to 5 wt % of crosslinking agent, such as a polycarboxylic acid containing a sulfonic acid group or a salt thereof; and a range of about 1 wt % to 10 wt %, for example 2 wt % to 7 wt % or 2 wt % to 5 wt % of one or more of a phosphorus-based compound and a phosphorus-based ammonium compound.

A method for manufacturing the aerogel-containing layer is described in detail below.

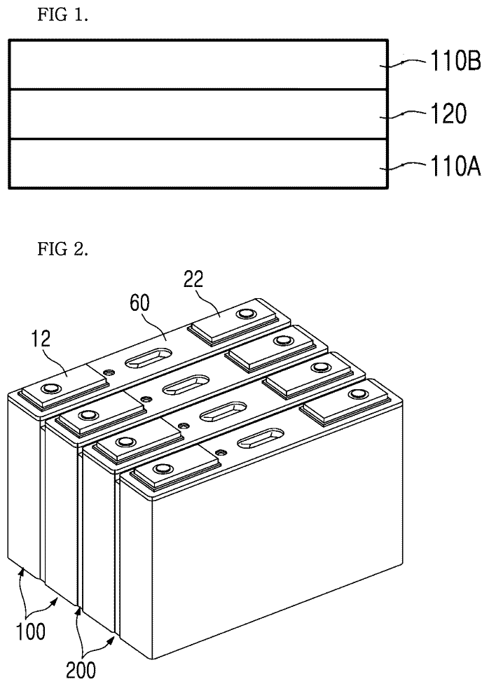

FIG. 1 shows a cross-sectional view of a heat insulating sheet for a rechargeable lithium battery according to one example embodiment.

Referring to FIG. 1, a heat insulating sheet for a rechargeable lithium battery may include a first base layer 110A, a second base layer 110B, and an aerogel-containing layer 120 between the first base layer 110A and the second base layer 110B.

Hereinafter, the method for manufacturing the heat insulating sheet according to one example embodiment is described.

The method for manufacturing the heat insulating sheet includes preparing a composition for an aerogel-containing layer including at least one of a fibrous support, an aerogel, an alcohol-based binder, and a crosslinking agent; applying the composition for an aerogel-containing layer on a first base layer and covering the composition with a second base layer; and drying and curing the composition for an aerogel-containing layer applied on the first base layer.

The fibrous support, aerogel, alcohol-based binder and crosslinking agent are the same as described above. The composition for an aerogel-containing layer may further include one or more of the dispersant, the silane-based compound, and the additive.

The composition for an aerogel-containing layer may further include a solvent. The solvent may include one or more of a polar solvent and a non-polar solvent.

The polar solvent may include at least one of water, an alcohol-based solvent, or a combination thereof. The water may include, for example, purified water, ultrapure water, or a combination thereof. The alcohol-based solvent may include, for example, one or more of methanol, ethanol, propanol, pentanol, butanol, hexanol, ethylene glycol, propylene glycol, diethylene glycol, and glycerol.

The non-polar solvent may include a hydrocarbon-based solvent. For example, the hydrocarbon-based solvent may include one or more of an aliphatic hydrocarbon solvent such as hexane, pentane, heptane, and the like, for example, an alkane solvent, and an aromatic hydrocarbon solvent such as toluene, benzene, and the like.

For example, the solvent may include water. When water is used as a solvent, the raw material costs and post-processing costs can be effectively reduced.

The solvent may be included so that a weight ratio of the solvent and the total solid content of the composition for an aerogel-containing layer is in a range of about 1:1 to about 1:90. For example, the weight ratio of the solvent and the total solid content of the composition for an aerogel-containing layer may be 1:50 to 1:70, 1:20 to 1:30, or 1:2 to 1:10. Within the above range, the composition for an aerogel-containing layer can be coated by controlling the viscosity of the composition for an aerogel-containing layer.

The composition for an aerogel-containing layer may be prepared using the solvent, the fibrous support, the aerogel, the binder, the crosslinking agent, and one or more of a phosphorus-based compound and a phosphorus-based ammonium compound.

According to one example embodiment, the composition for an aerogel-containing layer may be prepared by mixing an alcohol-based binder, a crosslinking agent, and one or more of a phosphorus-based compound and a phosphorus-based ammonium compound in a solvent to prepare a first mixture (first step); mixing the first mixture with an aerogel to prepare a second mixture (second step); and mixing the second mixture with a fibrous support to prepare a composition for an aerogel-containing layer (third step). In the step of preparing the first mixture, the dispersant, the silane-based compound, the additive, and the like may be additionally mixed.

In each of first to third steps, mixing may be performed using a mixer. For example, the mixer may be a planetary mixer or a Thinky mixer.

The planetary mixer may include one of one or more types of planetary blades and one or more types of high-speed dispersing blades. The planetary blades and high-speed dispersing blades rotate continuously about their axes. The rotational speed may be expressed in revolutions per minute (rpm).

According to one example embodiment, the planetary mixer may include a first blade and a second blade having different axes of rotation. For example, the first blade may be a low-speed blade and the second blade may be a high-speed blade. Herein, low speed and high speed refers to relative rotational speeds. For example, the first blade may be an open blade, and the second blade may be a Despa blade. The rotational speed of the first blade may be, for example, in a range of about 10 rpm to about 100 rpm or 10 rpm to 60 rpm. The rotational speed of the second blade may be in a range of about 100 rpm to about 2000 rpm.

The aerogel-containing layer may be manufactured by applying the composition for an aerogel-containing layer and then drying it. The drying may be performed at a temperature in a range of about 25° C. to about 100° C., 45° C. to 90° C., or 60° C. to 85° C. Within the above range, an aerogel-containing layer having desired or improved mechanical strength can be formed without a separate adhesive member or adhesive while reducing or preventing peeling between the first base layer and the aerogel-containing layer and between the aerogel-containing layer and the second base layer.

### Rechargeable Lithium Battery Module:

Another example embodiment includes a rechargeable lithium battery module including a plurality of battery cells arranged to face each other; and the heat insulating sheet for a rechargeable lithium battery arranged between the plurality of battery cells.

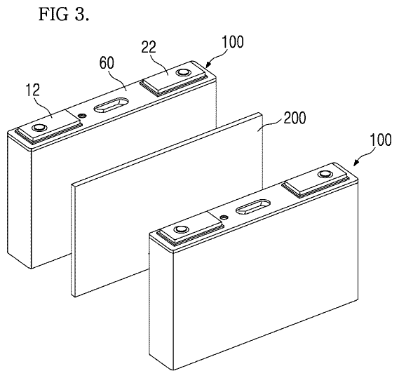

FIGS. 2 and 3 show a perspective view and an exploded view of a rechargeable lithium battery module according to one example embodiment, respectively.

Referring to FIGS. 2 and 3, a rechargeable lithium battery module may include a plurality of battery cells 100 arranged to face each other; and a heat insulating sheet 200 for a rechargeable lithium battery disposed between the battery cells 100.

The heat insulating sheet 200 for a rechargeable lithium battery may have a plate shape, and one side of the heat insulating sheet 200 is in contact with one side of one battery cell 100, and the other side, which is the opposite side of the one side, may be in contact with one side of another battery cell 100.

The battery cell 100 may include a case that accommodates an electrode assembly including a positive electrode and a negative electrode; a cap plate 60 coupled to the case to seal the case; and a positive electrode terminal 12 and a negative electrode terminal 22 that are electrically connected to the positive electrode and the negative electrode of the electrode assembly and protrude outward from the cap plate 60.

The positive electrode may include a current collector and a positive electrode active material layer formed on the current collector. The positive electrode active material layer includes a positive electrode active material and may further include a binder and/or a conductive material. The content of the positive electrode active material may be in a range of about 90 wt % to about 99.5 wt % based on 100 wt % of the positive electrode active material layer, and the contents of the binder and conductive material may each be in a range of about 0.5 wt % to about 5 wt % based on 100 wt % of the positive electrode active material layer.

Al may be included as the current collector, but is not limited thereto.

As the positive electrode active material, a compound capable of reversible intercalation and deintercalation of lithium (lithiated intercalation compound) may be used. For example, one or more of composite oxides of lithium and a metal such as or including at least one of cobalt, manganese, nickel, and a combination thereof may be used.

The composite oxide may be or include a lithium transition metal composite oxide, and examples thereof include at least one of lithium nickel-based oxides, lithium cobalt-based oxides, lithium manganese-based oxides, lithium iron phosphate-based compounds, cobalt-free nickel-manganese-based oxides, or a combination thereof.

As an example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≥0.5, 0≤c≤0.05); LiₐNi_{1-b-c}Co_{b}X_{c}O_{2-α}D_{α} (0.90≤a≤1.8, 0≤b≥0.5, 0≤c≤0.5, 0<α<2); LiₐNi_{1-b-c}—Mn_{b}X_{c}O_{2-α}D_{α} (0.90≤a>1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d<0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The negative electrode includes a current collector and a negative electrode active material layer located on the current collector. The negative electrode active material layer includes a negative electrode active material and may further include a binder and/or a conductive material. For example, the negative electrode active material layer may include about 90 wt % to about 99 wt % of the negative electrode active material, about 0.5 wt % to about 5 wt % of the binder, and about 0 wt % to about 5 wt % of the conductive material.

The negative electrode active material includes at least one of a material capable of reversibly intercalating/deintercalating lithium ions, a lithium metal, an alloy of lithium metal, a material capable of doping and dedoping lithium, or a transition metal oxide.

The material capable of reversibly intercalating/deintercalating lithium ions may be or include a carbon-based negative electrode active material, for example, crystalline carbon, amorphous carbon, or a combination thereof. Examples of the crystalline carbon include graphite such as natural graphite or artificial graphite, and examples of the amorphous carbon include at least one of soft carbon or hard carbon, mesophase pitch carbide, calcined coke, and the like.

As the material capable of doping and dedoping lithium, a Si-based negative electrode active material or a Sn-based negative electrode active material may be included. The Si-based negative electrode active material may be or include at least one of silicon, a silicon-carbon composite, SiOₓ (0<x<2), a Si-based alloy, or a combination thereof.

The silicon-carbon composite may be or include a composite of silicon and amorphous carbon. According to one example embodiment, the silicon-carbon composite may be in the form of silicon particles and amorphous carbon applied on the surface of the silicon particles.

The silicon-carbon composite may further include crystalline carbon. For example, the silicon-carbon composite may include a core including crystalline carbon and silicon particles, and an amorphous carbon coating layer located on the surface of the core.

The binder may be or include at least one of a non-aqueous binder, an aqueous binder, a dry binder, or a combination thereof. When using an aqueous binder as the negative electrode binder, a cellulose-based compound capable of imparting viscosity may be further included.

The negative electrode current collector may be or include at least one of a copper foil, a nickel foil, a stainless steel foil, a titanium foil, a nickel foam, a copper foam, a polymer base coated with a conductive metal, and a combination thereof.

An electrolyte for the rechargeable lithium battery includes a non-aqueous organic solvent and a lithium salt.

The non-aqueous organic solvent may constitute a medium through which ions involved in the electrochemical reaction of the battery can move. The non-aqueous organic solvent may be or include at least one of a carbonate-based, ester-based, ether-based, ketone-based, or alcohol-based solvent, an aprotic solvent, or a combination thereof, and may be included alone or in combination of two or more thereof.

In addition, when using the carbonate-based solvent, a cyclic carbonate and a chain carbonate may be included in combination.

Depending on the type of rechargeable lithium battery, a separator may be present between the positive and negative electrodes. As such a separator, at least one of polyethylene, polypropylene, polyvinylidene fluoride or a multilayer film of two or more thereof may be included.

The separator may include a porous substrate, and a coating layer including an organic material, an inorganic material, or a combination thereof located on one side or both sides of the porous substrate.

The organic material may include a polyvinylidene fluoride-based polymer or a (meth)acrylic polymer. The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. The organic material and inorganic material may be present in a mixed form in one coating layer, or may be present in a laminated form with a coating layer including the organic material and a coating layer including the inorganic material.

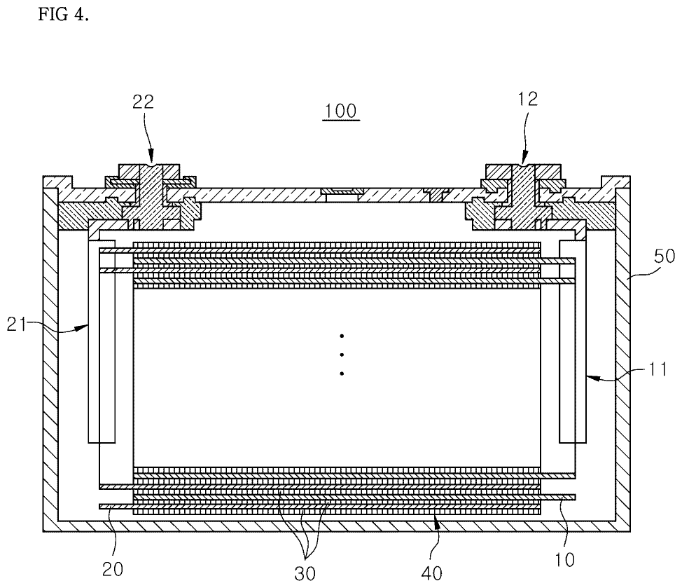

FIG. 4 shows a cross-sectional view schematically illustrating a battery cell 100 according to one example embodiment;

Referring to FIG. 4, a battery cell 100 may include an electrode assembly 40 including a positive electrode 10, a negative electrode 20, and a separator 30 interposed between the positive electrode 10 and the negative electrode 20, a case 50 in which the electrode assembly 40 is accommodated, a positive electrode lead tab 11 connected to the positive electrode 10, a positive electrode terminal 12 connected to the positive electrode lead tab 11, a negative electrode lead tab 21 connected to the negative electrode 20, and a negative electrode terminal 22 connected to the negative electrode lead tab 21.

A rechargeable lithium battery module according to one example embodiment may be applicable to, e.g., vehicles, mobile phones, and/or various types of electrical devices, but the present disclosure is not limited thereto.

The rechargeable lithium battery module according to the above-described example embodiment can be included to manufacture a battery pack.

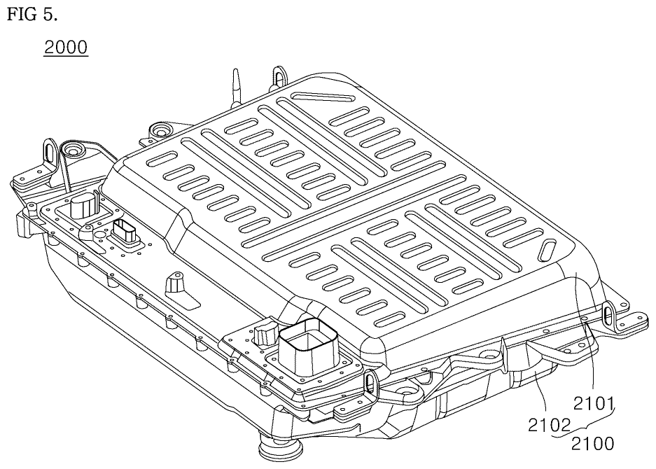

FIG. 5 shows a view illustrating a battery pack according to one example embodiment.

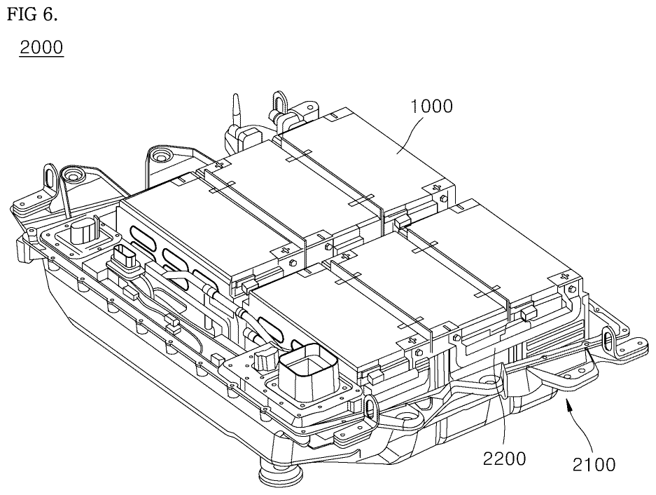

FIG. 6 shows a view illustrating a battery pack according to one example embodiment.

A battery pack 2000 according to one example embodiment includes an assembly of electrically connected individual batteries and a pack case accommodating the assembly. In the drawing, for the convenience of illustration, parts such as bus bars, cooling units, and external terminals for electrical connection of batteries are omitted.

For example, the battery pack 2000 may include a plurality of battery modules 1000 (e.g., including the battery modules described in FIG. 5) and a pack case 2100 for accommodating the battery modules 1000. For example, the pack case 2100 may include first and second pack cases 2101 and 2102 that are coupled facing each other with a plurality of battery modules 1000 are interposed therebetween. The plurality of battery modules 1000 may be electrically connected to each other using a bus bar 2200, and the plurality of battery modules 1000 may be electrically connected to each other in a series/parallel or series-parallel hybrid manner to obtain a required electrical output.

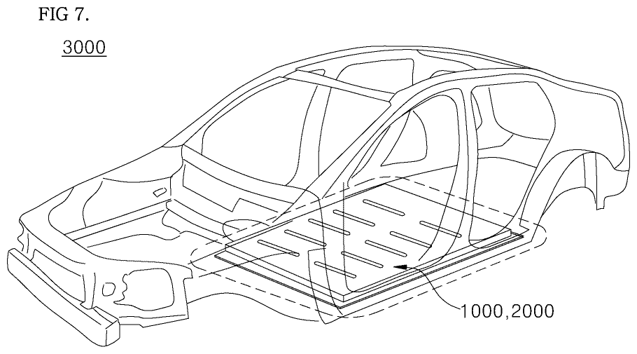

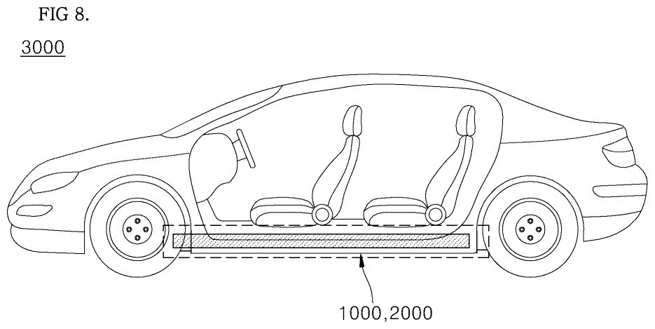

FIG. 7 shows a drawing illustrating a vehicle body and vehicle body parts according to one example embodiment.

FIG. 8 shows a drawing illustrating a vehicle body and vehicle body parts according to one example embodiment.

The battery pack 2000 according to one example embodiment described in FIGS. 5 and 6 can be mounted in a vehicle 3000. The vehicle 3000 may be, for example, an electric vehicle, a hybrid vehicle or a plug-in hybrid vehicle, or the like. The vehicle includes a four-wheeled vehicle or a two-wheeled vehicle.

As illustrated in FIGS. 7 and 8, the vehicle 3000 according to one example embodiment includes the battery module 1000 and/or the battery pack 2000 including the battery module 1000 according to one example embodiment. The vehicle 3000 operates by receiving power from the battery module 1000 and/or the battery pack 2000 including the battery module 1000 according to one example embodiment.

Hereinafter, examples and comparative examples of the present disclosure are described. However, the following examples are given for the purpose of illustration only, and the present disclosure is not limited to the following examples.

### EXAMPLE 1

### Preparation of Composition for Aerogel-Containing Layer

Polyvinyl alcohol (Sigma-Aldrich, PVA) as a binder, sulfosuccinic acid, and ammonium dehydrogen phosphate (ADP) were added to ultrapure water as a solvent and mixed using an open blade (30 rpm) and a Despa blade (700 rpm) to prepare a first mixture. An aerogel (BET surface area of 800 m²/g) was added to the first mixture and mixed using an open blade (70 rpm) and a Despa blade (1500 rpm) to prepare a second mixture. Glass wool was added to the second mixture and mixed using an open blade (30 rpm) and a Despa blade (1200 rpm) to prepare a composition for an aerogel-containing layer. A planetary mixer (Dientec, PT-005) was used for mixing.

The composition for an aerogel-containing layer prepared above is in the form of a slurry and includes, based on solid content, 6 wt % of polyvinyl alcohol, 2 wt % of sulfosuccinic acid, 60 wt % of aerogel, 27 wt % of glass wool, and 5 wt % of ADP.

### Manufacture of Heat Insulating Sheet

The composition for an aerogel-containing layer prepared above was applied onto a 0.1 mm thick mica sheet (Famica, Muscovite) as a first base layer, and a 0.1 mm thick mica sheet (Famica, Muscovite) as a second base layer was laminated on the composition for an aerogel-containing layer and coated using a roll pressing method. Then, the resultant was dried at 80° C. for 24 hours to manufacture a base sheet with a total thickness of 1.5 mm in which the mica sheet, the aerogel-containing layer, and the mica sheet were sequentially laminated.

### EXAMPLES 2 to 4

A heat insulating sheet was manufactured in the same manner as in Example 1, with a difference that the content of each component in the composition for an aerogel-containing layer in Example 1 was changed as shown in Table 1 below.

### Comparative Example 1

A heat insulating sheet was manufactured in the same manner as in Example 1, with a difference that sulfosuccinic acid was not used in the composition for an aerogel-containing layer in Example 1 and the content of each component was changed as shown in Table 1 below.

### Comparative Example 2

A heat insulating sheet was manufactured in the same manner as in Example 1, with a difference that boric acid was used instead of the sulfosuccinic acid in Example 1.

### Comparative Example 3

A heat insulating sheet was manufactured in the same manner as in Example 1, with a difference that polyurethane was used as a binder instead of polyvinyl alcohol in Example 1 and the content of each component was changed as shown in Table 1 below.

The following physical properties were evaluated for the compositions for the aerogel-containing layers and heat insulating sheets manufactured in the examples and comparative examples.

(1) Dispersibility: Dispersibility was evaluated visually. When the slurry phase was stable, dispersibility was evaluated as ○, and when the wetting of the aerogel was poor, or when the glass wool clumped and the phase was separated, dispersibility was evaluated as X.

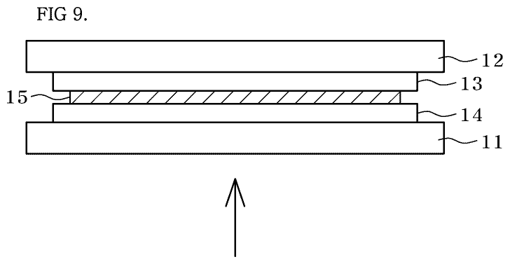

(2) Heat insulation (units: second): The manufactured heat insulating sheet was cut to manufacture specimens with a width of 232 mm and a depth of 115 mm, and each heat insulating sheet was placed between a pair of opposing 0.4T thick copper plates and placed on a heat press, and the upper plate of the heat press was heated to 600° C., and the lower plate of the heat press was not heated and maintained at the starting temperature of 40° C. Then, the time taken for the temperature of the lower plate to increase from 40° C. to 300° C. was measured while applying a pressure of 3500 kgf to the lower plate of the heat press. The longer the measurement time, the better the heat insulation. FIG. 9 shows a schematic diagram for evaluating heat insulation. Referring to FIG. 9, copper plates 14 and 13 are laminated between the heat press lower plate 11 and the heat press upper plate 12, and a heat insulating sheet specimen 15 is positioned between the copper plates.

(3) Breaking strength (units: kg/cm²): To check the durability of the heat insulating sheet, the maximum pressure at which the heat insulating sheet breaks was measured using a Mullen Bursting Tester (QM550A, QMESYS). A 100 mm×100 mm specimen was manufactured, placed on the tester, the central rubber diaphragm was expanded to break the heat insulating sheet, and the maximum pressure at which breaking occurred was measured. A higher breaking strength indicates a better durability.

(4) Fire resistance (units: Good/Poor): The manufactured heat insulating sheet was cut to manufacture specimens with a width of 100 mm and a depth of 70 mm, and a temperature sensor was mounted on the heat insulating sheet. Using a torch capable of radiating a flame on the mounted specimen side, the flame was applied for 5 minutes until the temperature of the surface of the heat insulating sheet reached 1200° C. When the flame was applied for 5 minutes, a condition in which cracks on the exterior of the heat insulating sheet did not penetrate to the back surface and collapse was judged as good, and a condition in which cracks penetrated and collapsed was judged as bad.

(5) Moisture resistance (units: %): The manufactured heat insulating sheet was cut to manufacture specimens with a width of 100 mm and a depth of 70 mm, and then weighed. Then, the specimen was weighed using the same method after absorbing moisture at 60° C. and 80% relative humidity for 24 hours. Moisture resistance was evaluated by a measurement and evaluation method of the weight increase rate. A lower weight increase rate indicates better moisture resistance.

TABLE 1

| | Examples | | | | Comparative Examples | | |
|---|---|---|---|---|---|---|---|
| | 1 | 2 | 3 | 4 | 1 | 2 | 3 |
| Polyvinyl | 6 | 7.5 | 10 | 15 | 8 | 6 | 0 |
| alcohol | | | | | | | |
| Sulfosuccinic | 2 | 0.5 | 3 | 5 | 0 | 0 | 2 |
| acid | | | | | | | |
| Aerogel | 60 | 60 | 60 | 60 | 60 | 60 | 60 |
| Glass wool | 27 | 27 | 20 | 13 | 27 | 27 | 20 |
| ADP | 5 | 5 | 7 | 7 | 5 | 5 | 5 |
| Boric acid | 0 | 0 | 0 | 0 | 0 | 2 | 0 |
| Polyurethane | 0 | 0 | 0 | 0 | 0 | 0 | 13 |
| Sum | 100 | 100 | 100 | 100 | 100 | 100 | 100 |
| Dispersion | ◯ | ◯ | ◯ | ◯ | ◯ | X | X |
| preparation | | | | | | | |
| Heat insulation | 501 | 496 | 507 | 479 | 456 | — | — |
| Breaking | 6.7 | 6.6 | 6.4 | 6.4 | 1.5 | — | — |
| strength | | | | | | | |
| Fire resistance | Good | Good | Good | Good | Poor (cracks | — | — |
| | | | | | occurrence) | | |
| Moisture | 2.1% | 2.2% | 3.8% | 4.0% | 8.2% | — | — |
| resistance | | | | | | | |

As shown in Table 1 above, the heat insulating sheet of the examples exhibits desired or improved heat insulation, durability, fire resistance, and moisture resistance. In addition, the composition for an aerogel-containing layer of the examples exhibits desired or improved dispersibility, so that the slurry phase was stable, and poor wetting of the aerogel, clumping of the glass wool, and phase separation did not occur.

However, the heat insulating sheet of Comparative Example 1 having an aerogel-containing layer formed of a composition not containing sulfosuccinic acid, as shown in Table 1 above, exhibits poor durability, fire resistance, and moisture resistance. In addition, Comparative Example 2, which included boric acid instead of sulfosuccinic acid as a crosslinking agent, and Comparative Example 3, which included polyurethane instead of polyvinyl alcohol as a binder, could not be evaluated because dispersibility was poor and thus heat insulating sheets could not be manufactured.

A heat insulating sheet for a rechargeable lithium battery according to one example embodiment can improve the safety of a module by reducing or suppressing heat propagation and/or heat transfer within the module by providing desired or improved heat insulation.

A heat insulating sheet for a rechargeable lithium battery according to one example embodiment has desired or improved durability, moisture resistance, and fire resistance, thereby improving the lifespan of a module.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A heat insulating sheet for a rechargeable lithium battery, the heat insulating sheet comprising:
a first base layer, an aerogel-containing layer, and a second base layer that are laminated,
wherein the aerogel-containing layer includes:
a fibrous support;
an aerogel;
one or more of a phosphorus-based compound and a phosphorus-based ammonium compound; and
a crosslinked product of a binder and a crosslinking agent,
the binder includes an alcohol-based binder, and
the crosslinking agent includes a polycarboxylic acid containing a sulfonic acid group (SO₃H) or a salt thereof.

2. The heat insulating sheet of claim 1, wherein the alcohol-based binder comprises a hydroxyl group connected to a main chain.

3. The heat insulating sheet of claim 1, wherein the alcohol-based binder comprises a repeating unit of the following Chemical Formula 1: 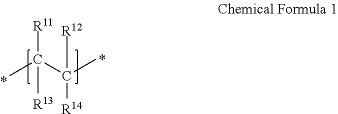
in Chemical Formula 1,
* is a connecting site of an element,
R¹¹ to R¹⁴ are each independently hydrogen, deuterium, a hydroxyl group, an unsubstituted straight or branched C1 to C5 alkyl group, or a straight or branched C1 to C5 alkyl group substituted with a hydroxyl group, and
at least one of R¹¹ to R¹⁴ is a hydroxyl group, or a straight or branched C1 to C5 alkyl group substituted with a hydroxyl group.

4. The heat insulating sheet of claim 1, wherein the alcohol-based binder comprises polyvinyl alcohol.

5. The heat insulating sheet of claim 1, wherein the alcohol-based binder comprises an aqueous binder.

6. The heat insulating sheet of claim 1, wherein the polycarboxylic acid containing a sulfonic acid group or a salt thereof is represented by the following Chemical Formula 2: 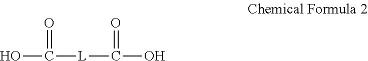
in Chemical Formula 2,
L is a straight or branched C1 to C10 alkylene group substituted with a sulfonic acid group or a salt thereof.

7. The heat insulating sheet of claim 1, wherein the polycarboxylic acid containing a sulfonic acid group or a salt thereof is represented by the following Chemical Formula 3: 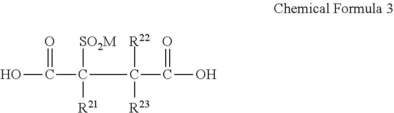
in Chemical Formula 3,
R²¹ to R²³ are each independently hydrogen, deuterium, or a substituted or unsubstituted C1 to C5 alkyl group, and
M is OH or O⁻N⁺ (where N⁺ is a monovalent metal cation).

8. The heat insulating sheet of claim 1, wherein the polycarboxylic acid comprises sulfosuccinic acid.

9. The heat insulating sheet of claim 1, wherein the polycarboxylic acid is included in an amount in a range of about 95 wt % or more of the crosslinking agent.

10. The heat insulating sheet of claim 1, wherein the aerogel is hydrophobically treated.

11. The heat insulating sheet of claim 1, wherein the fibrous support comprises glass wool.

12. The heat insulating sheet of claim 1, wherein a composition for the aerogel-containing layer comprises, based on solid content:
about 10 wt % to 70 wt % of the fibrous support;
about 10 wt % to 90 wt % of the aerogel;
about 1 wt % to 10 wt % of one or more of the phosphorus-based compound and the phosphorus-based ammonium compound;
about 0.5 wt % to 20 wt % of the binder; and
about 0.1 wt % to 10 wt % of the crosslinking agent.

13. The heat insulating sheet of claim 1, wherein at least one of the first base layer and the second base layer comprises a mica sheet.

14. A rechargeable lithium battery module comprising:
a plurality of battery cells arranged to face each other; and
the heat insulating sheet of claim 1 between the plurality of battery cells.
